(19) United States
(12) Patent Application Publication
(10) Pub. No.: US 2008/0080389 A1
(43) Pub. Date: Apr. 3, 2008

(54) Methods and apparatus to develop management rules for qualifying broadband services

(76) Inventors: Richard D. Hart, Concord, CA (US); Donggen Zhang, Fremont, CA (US); Xiaochuan Yi, San Ramon, CA (US); Kevin Meng, San Ramon, CA (US); Raghvendra Gurudath Savoor, Walnut Creek, CA (US)

Correspondence Address: HANLEY, FLIGHT & ZIMMERMAN, LLC, 150 S. WACKER DRIVE, SUITE 2100, CHICAGO, IL, 60606, US

(21) Appl. No.: 11/542,292

(22) Filed: Oct. 3, 2006

(51) Int. Cl. H04J 1/16

(52) U.S. Cl. 370/252

(57) ABSTRACT

Methods and apparatus are disclosed to develop management rules for qualifying broadband services. An example method disclosed herein includes receiving a time period to analyze broadband network spectral compatibility, retrieving circuit operating metrics of a first and a second twisted copper pair circuit during the time period, and qualifying at least one of a first or a second plain old telephone system (POTS) twisted copper pair circuit for broadband services to determine the network spectral compatibility based on the operating metrics.

### FIELD OF THE DISCLOSURE

This disclosure relates generally to plain old telephone system (POTS) copper pair circuits, and, more particularly, to methods and apparatus to develop management rules for qualifying broadband services.

### BACKGROUND

Service providers may offer a wide variety of communication services to subscribers, such as plain old telephone services (POTS), voice-over-internet protocol (VoIP) services, Internet connectivity services, and/or broadcast programming services, such as television and/or audio services. Some service providers own, maintain, and upgrade some or all of their own communication networks that provide one or more of these services to their subscriber base. These communication networks may include a vast array of geographically distributed twisted pair copper cable(s), fiber-optic cable(s), routers, switches, servers, repeaters, signal control points (SCPs), signal switching points (SSPs), databases, and/or digital pair gain (DPG) devices, to name a few examples.

Twisted copper pairs of the POTS infrastructure were largely limited to a transmission spectrum of 4 kHz when originally installed. Through many decades of POTS infrastructure installation and maintenance, engineering rules have been carefully established based on observed performance effects. For example, it has been determined that various quality metrics/parameters of cable binders carrying hundreds of copper twisted pair circuits would begin to deteriorate when their length exceeded a finite length. Generally speaking, increasing the number of twisted copper pairs used for broadband transmission in a binder results in increased occurrences of crosstalk and other interference effects, which typically contribute to performance degradation. These established engineering rules have been used during POTS infrastructure installations in lieu of exhaustive empirical per-circuit testing, thereby saving installation crews significant amounts of time.

### BRIEF DESCRIPTION OF THE DRAWINGS

FIG. 1 is a schematic diagram illustrating an example system to qualify circuits for broadband services.

FIG. 2 is a more detailed illustration of the example network planner of FIG. 1.

FIG. 3 is a portion of an example topology table of the example system of FIG. 1.

FIG. 4 is a portion of an example performance table of the example system of FIG. 1.

FIG. 5 is an example eye diagram that may be measured by the example system of FIG. 1.

FIG. 6 is an example graphical user interface (GUI) for the example system of FIG. 1.

FIG. 7 is an example output plot that may be generated by the example system of FIG. 1.

FIGS. 8-10 are flow diagrams representative of example machine readable instructions which may be executed to implement the example system of FIG. 1.

FIG. 11 is a schematic illustration of an example computer that may execute the example processes of FIGS. 8-10 to implement the example system of FIG. 1.

### DETAILED DESCRIPTION

Methods and apparatus are disclosed to develop management rules for qualifying broadband services. An example method disclosed herein includes receiving a time period to analyze broadband network spectral compatibility, retrieving circuit operating metrics of a first and a second twisted copper pair circuit during the time period, and qualifying at least one of a first or a second plain old telephone system (POTS) twisted copper pair circuit for broadband services to determine the network spectral compatibility based on the operating metrics.

Broadband services, such as digital subscriber line (DSL) services, provide digital and/or voice data transmission over wires of a telephone network. DSL implementation is particularly attractive because it can take advantage of legacy plain old telephone services (POTS) networks that have been installed and maintained for several decades. The POTS networks that exist in most geographic regions of the world employ copper twisted pair wires (“cable pairs”) for households, apartments, and/or condominiums. In some instances, hundreds of the individual cable pairs are combined to form an aggregate bundled cable to span relatively long distances. The bundled cable(s) typically leave a central office (CO) and terminate at an entrance bridge for larger bundled cable distribution and/or circuit separation. For example, a large community subdivision may have a single large entrance bridge to receive the bundled cable from the CO. Several larger bundled cables, each containing, for example, multiples of 25-pair binder groups, may exit the entrance bridge and terminate at a smaller tap (i.e., a small entrance bridge), in which each cable pair is individually routed to respective homes of the subdivision.

Broadband services, such as DSL, may provide high speed digital services (e.g., Internet access) to subscribers without interfering with POTS voice services. Some DSL standards, such as asynchronous DSL (ADSL) can deliver bit rates of approximately 8 Mbit/s over one mile of unshielded twisted pair copper wire. Persons of ordinary skill in the art will appreciate that DSL standards continue to improve, and that a more recent VDSL standard can deliver data rates exceeding 24 Mbit/s. Other DSL technologies include, but are not limited to, high data rate DSL (HDSL), symmetric DSL (SDSL), rate adaptive DSL (RADSL), very-high-bit-rate DSL version 2 (VDSL2), etc. Accordingly, a substantial cost savings may be realized if the service provider can provide broadband services for a subscriber base without expensive infrastructure upgrade(s). In particular, because the POTS infrastructure is ubiquitous in most subscriber markets, new cabling may not be necessary in many geographic areas.

A service provider may make a decision to employ broadband services on a POTS infrastructure with a relatively high degree of confidence if sufficient data exists to validate that decision. The POTS infrastructure includes copper twisted pair circuits and sheathed bundles of such circuits that were originally designed to accommodate an upper transmission spectrum of 4 kHz. Broadband network services, on the other hand, employ a transmission spectrum exceeding 10 MHz. Additionally, various broadband network technologies contain many different spectral compositions that were not observed factors of the POTS networks. The performance of broadband circuits depends on several factors, including transmission length, number of adjacent broadband circuits, power levels of the adjacent circuits, and/or transmission frequencies of the adjacent circuits. All of these factors, alone or in combination, may introduce various effects upon the data rate of one or more broadband circuits within an aggregate binder (i.e., a cable containing numerous individual twisted pair copper circuits, referred to as a bundled cable).

While topological data records may exist for many of the legacy POTS networks, performance data relating to broadband service capabilities of those POTS networks is generally unavailable. Installation crews have less historical data regarding broadband circuit performance on legacy POTS networks, thus time-saving rules are less likely to be employed when considering any particular POTS network for broadband services. As a result, service providers may attempt to populate various twisted pair copper circuits with new broadband services until performance characteristics degrade. Unfortunately, performance characteristic degradation may become evident by way of poor service complaints by one or more subscribers, thereby adversely affecting the service provider's business. Accordingly, the confidence of a decision to incorporate various types of broadband services on a POTS infrastructure is low when the number of measured data points relating to current and/or historical broadband performance metrics is low.

For example, an existing POTS infrastructure, such as a sheathed/bundled cable carrying one hundred individual cable pairs, may successfully provide subscribers with superior ADSL services. However, the service provider will not have confidence that a similar bundled cable can also accommodate fifty cable pair circuits of ADSL and fifty cable pair circuits of HDSL services unless performance metrics for a statistically significant number of samples of other such mixed configurations are known.

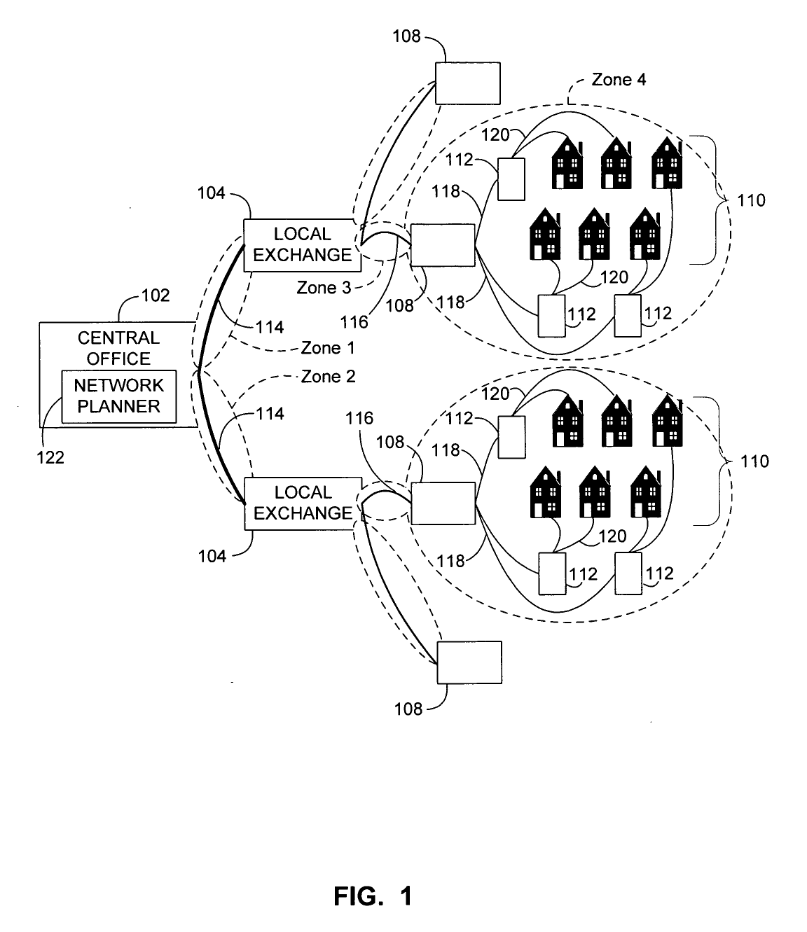

An example system for qualifying circuits for broadband services is shown in FIG. 1. The example system of FIG. 1 includes a CO 102 and two example local exchanges 104. Persons of ordinary skill in the art will appreciate that any number of local exchanges may be connected to the CO 102. The CO 102 can include a telephone company building where subscribers' lines are coupled to switching equipment to connect other subscribers to each other for local and/or long distance service. The CO 102 may also include an end of a switching station or public exchange. The CO 102 is not limited to providing telephone services to subscribers, but may also provide various broadband services to the subscribers including, but not limited to, video services, audio services, and/or high speed data services, such as high speed DSL services. The local exchanges 104 may be referred-to as an end office where subscribers' lines are terminated, typically to one or more entrance bridges 108, apartments, offices, and/or homes 110. Smaller entrance bridges, referred-to as taps 112 may be placed in various locations nearer the homes 110, which allow such homes to receive one or more cable pairs for telephone and/or broadband services.

Various network elements (NEs) may be employed between the CO 102 and the local exchange(s) 104. For example, a digital pair gain (DPG) may be used to multiplex a relatively large number of communication lines over a relatively lower number of communication mediums 114 (bundled cables) to make more efficient use of an infrastructure, such as the POTS infrastructure. For example, a DPG may use one cable pair to carry several simultaneous conversations. Furthermore, a DPG may multiplex new DSL services onto a subscriber's existing phone line. In the illustrated example, the POTS infrastructure includes the bundled cables 114 spanning from the CO 102 to the local exchanges 104, intermediate bundles 116 spanning from the local exchanges 104 to the entrance bridges 108, and bundles 118 containing a number of cable pairs (e.g., 5) that span from the entrance bridges 108 to the taps 112. The POTS infrastructure also includes individual copper pairs 120 that run from the taps 112 to respective ones of the individual homes 110.

In the illustrated example, a network planner 122 evaluates the POTS infrastructure, including, for instance, the bundled cables 114, the intermediate bundles 116, the small bundles 118, and/or the individual copper pairs 120 to determine whether broadband services can be provided on any particular section of the POTS infrastructure. As discussed in further detail below, the example network planner 122 of FIG. 1 may be located in the CO 102 to communicatively connect to one or more infrastructure zones. Additionally or alternatively, the example network planner 122 may be located at the local exchange 104. A network engineer (user) may designate any particular infrastructure zone to analyze. In the illustrated example, zone 1 refers to a bundled cable 114, zone 2 refers to another bundled cable 114, zone 3 refers to an intermediate bundle 116, and zone 4 refers to small bundles 118 and individual copper pairs 120. Persons of ordinary skill in the art will appreciate that the service provider and/or network manager may designate various facets of the infrastructure (e.g., sub-networks) with any nomenclature.

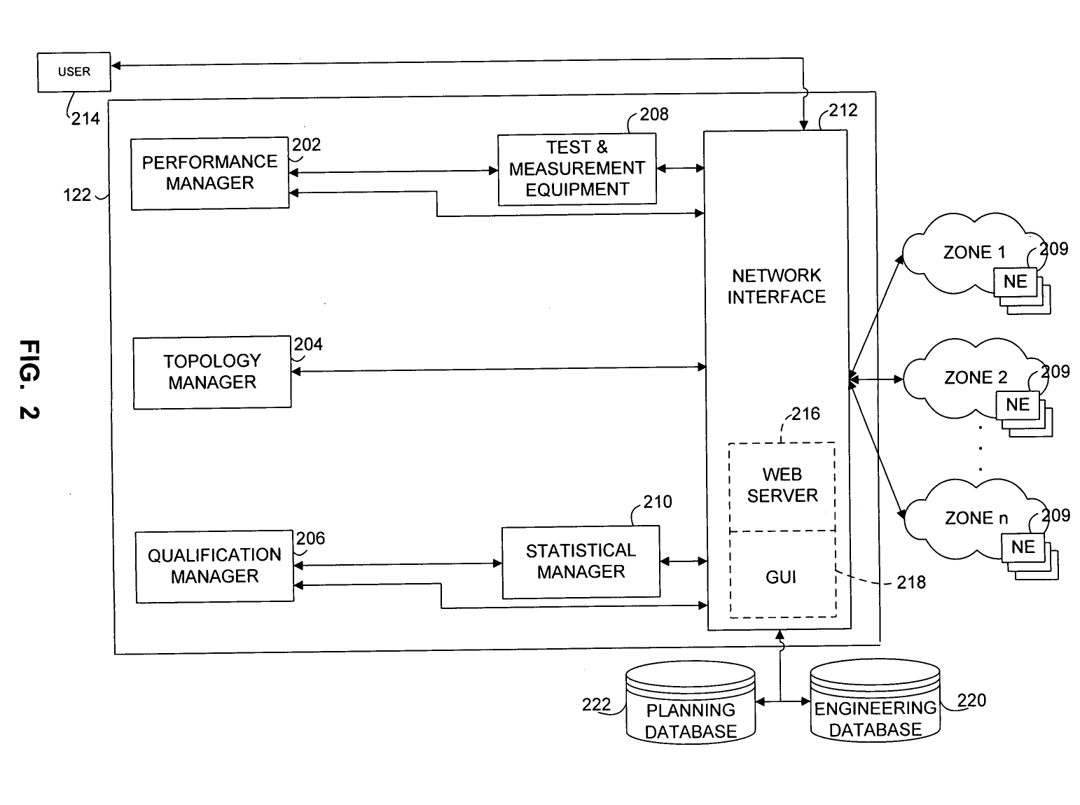

An example network planner 122 is shown in FIG. 2. The example network planner 122 of FIG. 2 includes a performance manager 202, a topology manager 204, and a qualification manager 206. In the illustrated example, the performance manager 202 accesses data from at least two types of sources. One source type includes T&M equipment 208, and the other source type include broadband network elements (NEs) 209, which may be located throughout various zones. The performance manager 202 is communicatively connected to the broadband NEs 209 to acquire broadband performance information produced in the course of its operation and the test and measurement (T&M) equipment 208 performs empirical tests on one or more of the various zones of the POTS infrastructure. The example qualification manager 206 is communicatively connected to a statistical manager 210 to execute one or more statistical algorithms and/or regression analysis on the infrastructure topology and/or performance data. The example broadband performance information measured and/or acquired from the zones may include, but is not limited to, bit rates, noise margins, signal attenuation, signal to noise margin, code violations, and/or re-initialization counters, whether measured at a single frequency or across the spectrum of broadband frequencies. The example T&M equipment 208 of FIG. 2 may include, but is not limited to, oscilloscopes, spectrum analyzers, network analyzers, logic analyzers, protocol analyzers/exercisers, bit error ratio (BER) testers, and/or signal generators. In the illustrated example of FIG. 2, all of the performance manager 202, the topology manager 204, the qualification manager 206, the T&M equipment 208, and the statistical manager 210 are communicatively connected to a network interface 212.

In the illustrated example, a user 214 accesses the network planner 122, and/or one or more services of one or more of the various managers (e.g., the performance manager 202, the topology manager 204, the qualification manager 206, the T&M equipment 208, and/or the statistical manager 210) via the network interface 212. User interaction and/or access to the network planner 122 may be accomplished via one or more of the Internet and/or an intranet, a computer, a workstation, a kiosk, etc. The network interface 212 of the illustrated example enables communication via web-pages using a web server 216 and/or via graphical and/or command-line user interfaces using one or more graphical user interfaces (GUIs) generated by a GUI module 218. Each of the aforementioned managers, as well as the T&M equipment 208, interacts with the network interface 212 to provide an interface for user/manager interoperability as well as to receive and process inputs related to qualifying POTS infrastructure for broadband services.

The example network planner 122 of FIG. 2 also includes an engineering database 220 to store infrastructure performance data acquired over an interval of time. In the illustrated example, the engineering database 220 includes current performance data, and a planning database 222 stores topological information related to the infrastructure layout, which may also be acquired over an interval of time from an indefinite past, including the current network infrastructure. For example, the example planning database 222 of FIG. 2 may include, but is not limited to, geographic location information, cable/wire gauge information, cable/wire length information, dates of cable/wire installation (e.g., age information) and/or repair, cable/wire type information (e.g., solid, stranded, etc.), cable sheath type information, broadband transceiver location information, cable/wire shielding information, and/or circuit identification information, such as the assigned telephone number of the circuit. The example planning database 222 of FIG. 2 may utilize standard industry nomenclature to identify cables and/or wires. For example, the planning database 222 may identify cables and/or wires as DSL circuits, ADSL circuits, ADSL2+ circuits, HDSL circuits, SDSL circuits, RADSL circuits, and/or VDSL circuits. Of course, the example planning database 222 of FIG. 2 may also refer to respective cables and/or wires of the infrastructure using other nomenclature such as descriptive nomenclature that recites, for example, circuit gauge, cable-type, and/or length. For example, an example planning database 222 entry may list “22AWG-Stranded-500/50/s” to represent a five hundred foot long shielded cable with fifty 22-gauge stranded twisted pairs.

As discussed above, the example engineering database 220 of FIG. 2 stores information relating to the performance of one or more sections of the POTS infrastructure, such as broadband circuit performance and metrics on particular lengths of bundled cables and/or individual twisted pairs acquired from T&M equipment. For example, the example engineering database 220 of FIG. 2 may include information related to transmission rates (e.g., up-direction bit rate(s), down-direction bit rate(s), etc.), signal power level(s), signal power spectral densities, signal-to-noise ratio information, jitter characteristics, transmission frequencies, eye-diagrams (e.g., bitmap, JPEG, etc.) and/or eye-diagram parameters (e.g., eye-width, eye-height, eye-jitter, eye-mask violation(s), etc.). Performance information stored on the engineering database 220 may also be associated with the date(s) and/or time(s) that such performance metrics were stored. Accordingly, cable and/or wire performance can be analyzed at different times of the day, different days of the week, to determine environmental effects. For example, while any one particular cable pair may exhibit characteristics of a high bit-rate during the regular weekday, that same cable pair may exhibit substantially worse performance characteristics when adjacent cable pairs are provisioned and turned up for network broadband services. As such, for any particular section of the POTS infrastructure (e.g., a single cable pair, a bundled sheath, etc.), the engineering database 220 may include multiple entries for the same metric (e.g., bit rate), with each entry representing a different time stamp (e.g., a day, a month, a year, an hour, minute, and/or second, etc.).

In the illustrated example, the network planner 122 accesses the engineering database 220 and the planning database 222 via the network interface 212. While the illustrated example of FIG. 2 includes a single engineering database 220 and a single planning database 222, persons of ordinary skill in the art will appreciate that multiple databases may be employed based on, for example, size constraints. Additionally or alternatively, the databases (220, 222) may be located remotely and accessible via an intranet and/or the Internet and/or the planning database 222 and the engineering database 220 may be combined.

The example performance manager 202 of the illustrated example is communicatively connected to the engineering database 220 via the network interface 212. As discussed in further detail below, the performance manager 202 accesses the engineering database 220 to extract data of interest on which to perform cable pair and/or bundled cable analysis. For example, the qualification manager 206 may request performance data for a particular cable pair during a particular time period. In response to this request, the performance manager 202 will parse the engineering database 220 to extract relevant performance characteristics during that specified time period. The performance characteristics returned may include, for example, the up-direction bit rate for a cable pair in zone “1” during a workday in March. The March time-period may be indicative of cable pair performance during a time interval prior to other broadband services being deployed into this section of cable. Similarly, the performance manager 202 may receive a request from the qualification manager 206 to extract performance data for the specified cable pair exactly one month prior, and one month after the introduction into the cable section of a multiplicity of other broadband services, thereby allowing analysis of cable pair performance in view of varying network usage.

The performance manager 202 of the illustrated example also controls the T&M equipment 208 in an effort to build-up useful data in the engineering database 220. Generally speaking, trends, correlations, and/or conclusions that are uncovered based on data analysis will have a higher degree of confidence if a greater number of data points are used during the analysis. Persons of ordinary skill in the art will appreciate that, in most contexts, data confidence increases when the sample size increases, because recurring data points tend to suggest that observed data is not merely the result of chance. Accordingly, the T&M equipment 208 of the illustrated example is employed to increase the number of empirical data points with which to perform calculations. As discussed above, the T&M equipment 208 of the illustrated example includes one or more electrical fault test systems. Persons having ordinary skill in the art will appreciate such electrical fault test systems are typically in an outside plant and may include metallic loop test instrumentation and/or specialty equipment. The equipment may include, but is not limited to spectrum analyzers, network analyzers, logic analyzers, protocol analyzers/exercisers, BER testers, and/or signal generators. Additionally, performance information is generated by broadband circuit transceivers as part of their broadband functions, which may be measured and/or collected by the example T&M equipment 208. The performance manager 202 may invoke the T&M equipment 208 on a periodic and/or aperiodic basis to acquire relevant data for any particular cable pair and/or bundled cable of the POTS infrastructure. Data returned by periodic, aperiodic, and/or manual invocation of the T&M equipment 208 may include, but is not limited to, up-direction bit rates, down-direction bit rates, signal power level(s), signal-to-noise ratio information, jitter, delay, transmission frequency, various eye-diagram parameters (e.g., eye-width, eye-height, eye-jitter, eye-mask violations, etc.), and/or electrical measurements including capacitive length, DC and AC voltages, and capacitive balance.

In addition to the data acquisition functions of the T&M equipment 208 performed on various zones of a POTS network, the T&M equipment 208 may also inject various signals on cable pairs and/or bundled cables to observe and record effects responsive to such signals. For example, in the illustrated example of FIG. 2, the performance manager 202 may instruct the T&M equipment 208 to excite a single cable pair (test-pair) within a bundled cable of zone “1.” Adjacent cable pairs are then measured to determine the severity of crosstalk as the test-pair is excited with, for example, varying power levels and/or frequencies. The T&M equipment 208 may excite one or more cable pairs within a bundled cable to measure and record the effects, if any, on adjacent cable-pairs within the bundled cable. Data acquired by the T&M equipment 208 is saved in the engineering database 220 for later use by the qualification manager 206 and/or the statistical manager 210, discussed in further detail below. Additionally or alternatively, the acquired data may be saved in a memory of the performance manager 202 for later analysis.

The topology manager 204 of the illustrated example is communicatively connected to the planning database 222 via the network interface 212. The topology manager 204 accesses the planning database 222 to extract data of interest on which to perform cable pair and/or bundled cable analysis. For example, the qualification manager 206 may request cable pair and/or bundled cable characteristic data for one or more zones of the POTS infrastructure. In response to this request, the topology manager 204 will identify the sections of the outside plant that meet the request and then receive relevant topology data from the planning database 222. The retrieved data is indicative of cable pair and/or bundled cable characteristics. As discussed above, the topology data may include, but is not limited to, geographic location information, cable/wire gauge information, cable/wire length information, dates of cable/wire installation (e.g., cable age information) and/or repair, cable/wire type information (e.g., solid, stranded, etc.), cable/wire shielding information, and/or a set of broadband circuits.

The topology data stored in the planning database 222 may be the result of data entry efforts by a service provider, communication carrier, and/or telecommunications company. Additionally or alternatively, data in the planning database 222 may be updated on a regular basis as a result of new cable pairs and/or bundled cable installation, and/or the provisioning of broadband circuits on distinct cable pairs. For example, upon the installation of new twisted pair cables and/or bundles of many twisted cable pairs, an installation technician may enter completed work orders in the database that identify, inter alia, the geographic location of the installation (e.g., zone, latitude, longitude, street address, etc.), the cable gauge, the cable length, the cable shielding (if any), the cable type (e.g., stranded copper, solid copper, etc.), the number of cable pairs comprising a cable bundle, and/or the expected services that the cable will provide (e.g., voice, DSL, ADSL, VDSL, etc.). Without limitation, an installation technician may enter data similar to the data stored in the planning database 222 upon completion of network infrastructure repairs, upgrades, and/or the provisioning of broadband circuits to identify which pairs are assigned to which broadband circuits.

In the event that a particular zone, cable pair, and/or bundled cable is removed and replaced with one or more new cable pairs and/or bundled cable(s), the planning database 222 maintains a history of that prior topological data. Similarly, the planning database 222 maintains a history of when a broadband circuit was provisioned in the network or de-commissioned from operation. Additionally, the engineering database 220 maintains a complete historical record of performance data from cable pair(s) and/or bundled cables that may no longer exist in a zone due to, for example, cable replacement. As such, the service provider, the communication carrier, and/or other owner/manager of a communication infrastructure may use the historical topological and/or engineering/performance data from the planning database 222 and/or the engineering database 220 to, respectively, ascertain whether a new installation configuration will be successful. For example, a user of the network planner 122 may run a regression analysis using topological and engineering data to learn more about the relationship between several independent variables and a dependent variable. For instance, a user (e.g., network analyst) may seek to determine if ADSL type broadband circuit up-direction data rate has a functional relationship to the number of HDSL circuits in the same cable binder. The user will select, for example, “Number of HDSL Circuits in Binder” as the independent variable, and select “Up-Direction Bit Rate” as the dependent variable. Performing a regression analysis upon these independent and dependent variables may illustrate relationships helpful for a network planner when deciding whether to utilize a legacy POTS infrastructure for particular broadband services. Such relationship data may indicate that the POTS infrastructure is likely to support the desired broadband services without performance issues, or the relationship data may indicate that the POTS infrastructure cannot satisfactorily support the intended broadband services without an upgrade or modification to the infrastructure (e.g., shielding the cable pairs and/or bundled cables, reducing the number of HDSL circuits in a single binder, decreasing signal power level(s) in the cable pair(s), etc.). These findings can be summarized as a set of rules for managing spectral compatibility for broadband services.

In the example of FIG. 2, the qualification manager 206 is communicatively connected to the statistical manager 210. The qualification manager 206 is also communicatively connected to the performance manager 202 and the topology manager 204 via the network interface 212. The qualification manager 206 controls the operations of the performance manager 202 and the topology manager 204, initiates analysis operations to be performed by the statistical manager 210 on data from the engineering database 220 and the planning database 222, and invokes the performance manager 202 to employ various test equipment of the T&M equipment 208 for data acquisition. The qualification manager 206 also stores a plurality of profiles to run various regression analysis operations on data from the engineering database 220 and/or the planning database 222. For example, the user may design a regression analysis procedure that employs a specific set of independent variables, dependent variables, a unique computational approach and/or a date range constraint for any particular zone, cable pair, and/or bundled cable. Rather than requiring the user to repeatedly enter all of the aforementioned analysis parameters before running the analysis, the qualification manager 206 stores such parameters in a profile for later use, as discussed in further detail below.

In the example of FIG. 2, the qualification manager 206 also invokes the services of the statistical manager 210. The statistical manager 210 may be a software application and/or module designed for specific numerical analysis purposes. For example, the statistical manager 210 may be, without limitation, the SAS® statistical forecasting program, reporting and analysis software sold by MicroStrategy8®, or the Mathematica® Experimental Data Analyst sold by Wolfram Research. Persons of ordinary skill in the art will appreciate that a vast array of statistical analysis applications and tools exist to perform regression analysis and/or other statistical techniques on data to forecast future performance and/or identify trends. Calculation(s) of various statistical functions may be requested by the qualification manager 206 and performed by the statistical manager 210 including, but not limited to, regression analysis, dynamic regression, trend analysis, exponential smoothing, standard deviation, Chi test(s), correlation analysis, and/or various confidence tests.

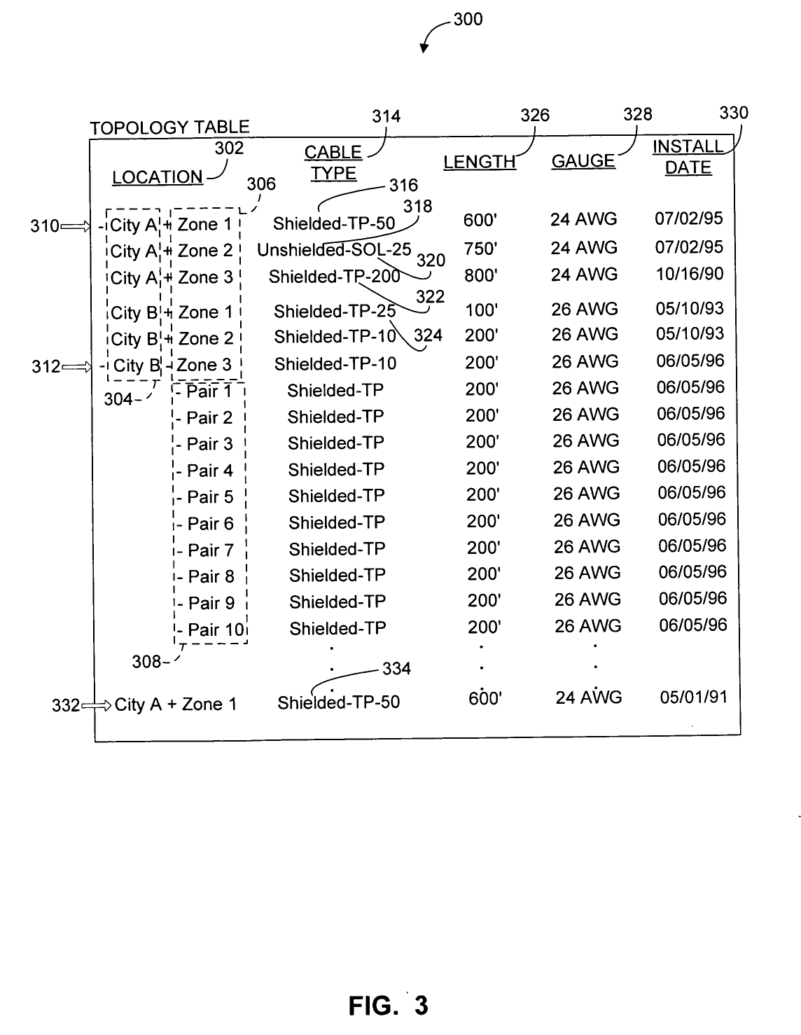

FIG. 3 illustrates an example topology table 300 that allows recording and recall of information regarding cable pair(s) and/or bundled cable(s) of a network, such as a POTS infrastructure of copper twisted pair cables of varying types and lengths. The example topology table 300 of FIG. 3 includes a location column 302 that identifies location and/or other geographical information regarding where a particular cable pair and/or bundled cable may be found. The user(s) may label such cable pairs with descriptive nomenclature to aid in efficient identification of infrastructure components (e.g., cable pairs, bundled cables, etc.). In the illustrated example of FIG. 3, the location column 302 includes a city identifier 304, a zone identifier 306, and a cable pair identifier 308. The city identifiers 304 and the zone identifiers 306 include a “+” or “−” symbol to allow the user(s) to adjust the geographic resolution display of location column 302 elements. For example, the city identifier 304 for “City A” (row 310) includes a “−” symbol, which illustrates that all known zones for city “A” are expanded and shown to the user(s) (i.e., “zone 1,” “zone 2,” and “zone 3”). Conversely, the “+” symbol shown in row 310 next to “zone 1” illustrates that zone “1” includes one or more cable pairs and/or bundled cables. The user(s) viewing the topology table 300 may select any “+” symbol to expand the list, and the user(s) may select any “−” symbol to collapse the list. In the illustrated example of FIG. 3, “zone 3” of “City B” has been expanded to show ten cable pairs (see row 312). However, persons of ordinary skill in the art will appreciate that any number of cable pairs may be shown after expanding a zone depending on, for example, the size of a bundled cable. Persons of ordinary skill in the art will also appreciate that expansion of a zone may also illustrate any number of bundled cables within that particular zone. For ease of illustration, the example zones of FIG. 3 illustrate a single bundled cable per zone. However, any number of bundled cables may be present in a zone.

The example topology table 300 of FIG. 3 also includes a cable type column 314 that identifies information indicative of various cable parameters to the user(s). In the illustrated example of FIG. 3, the cable type column 314 includes details indicating whether the corresponding bundled cables and/or cable pairs are shielded 316, unshielded 318, solid copper (“SOL”) 320, and/or twisted pair copper (“TP”) 322. In addition, the cable type column 314 may indicate the number of cable pairs within the bundled cable 324. Without limitation, any suitable nomenclature may be employed by the user(s), network administrator(s), service provider(s), communication carrier(s), and/or owners/operators of the communication infrastructure in the example table 300.

A length column 326 of the illustrated example topology table 300 of FIG. 3 includes a corresponding length value for each bundled cable and/or cable pair. While the example length column 326 illustrates measurement units in feet, any other measurement unit may be displayed (e.g., miles, meters, kilometers, etc.). A gauge column 328 of the illustrated example topology table 300 identifies a corresponding cable pair gauge parameter. The gauge column 328 displays cable pair diameter dimensions using the American Wire Gauge (AWG) method. However, any other method may be used without limitation. Persons of ordinary skill in the art will appreciate that the AWG method includes formulas to back-calculate specific diameter and/or cross-sectional area values. For example, a 24 AWG wire has a diameter of 0.5106 mm and an area of 0.205 mm². Row 310 illustrates that zone “1” of city “A” has a bundled cable with 50 shielded twisted pairs (TP) therein. Accordingly, the gauge column 328 identifies that each of those 50 shielded TPs has a gauge of 24 AWG.

An install date column 330 of the illustrated example topology table 300 of FIG. 3 includes the date on which the corresponding bundled cable and/or cable pair was installed in any particular location of a network infrastructure. As discussed above, the planning database 222 maintains both current and historical topology information of the network infrastructure. To that end, the user(s) will be presented with multiple rows having the same location identification information, but the corresponding cable type, length, gauge, and install date may be different. For example, row 332 illustrates a legacy configuration for city “A” and zone “1” that is no longer in use, as determined by older installation date information (“May 1, 1991”) in the install date column 330. On the other hand, row 310 also references city “A” and zone “1” with a more recent date (“Jul. 2, 1995”) when the cable type changed from “shielded-TP-25” (334) to “shielded-TP-50” (316). Persons of ordinary skill in the art will appreciate that the increase in the number of cable pairs from twenty-five in zone “1” to fifty may have been added, for example, to accommodate greater bandwidth needs for a growing neighborhood.

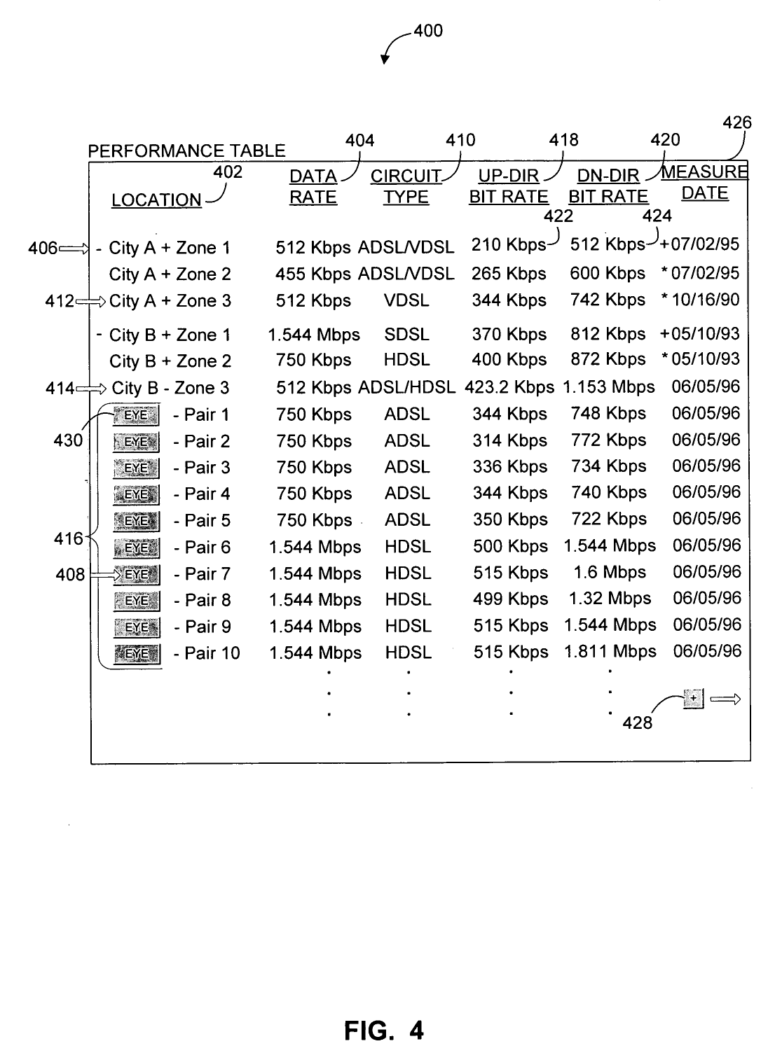

FIG. 4 illustrates an example performance table 400 that allows recording and recall of information regarding cable pair and/or bundled cable performance of a network, such as a POTS infrastructure of copper twisted pair cables of varying types and lengths. Much like the example topology table 300 of FIG. 3, the example performance table 400 of FIG. 4 includes a location column 402 that identifies location and/or other geographical information regarding where a particular cable pair and/or bundled cable may be found. The user(s) of the example network planner 122 may label such cable pairs/bundled cables with descriptive nomenclature to aid in efficient identification of infrastructure components, as discussed above.

In the illustrated example, a data rate column 404 identifies data rate information that corresponds to a particular zone and/or cable pair of the location column 402. In the illustrated example, the performance table 400 includes various bundled cables, represented by zones having a “+” symbol, and various cable pairs that are expanded and shown with a “−” symbol. Any particular data rate value in the data rate column 404 may refer to an average data rate of a corresponding bundled cable when the respective zone is not expanded, such as the example average data rate of 512 Kbps for the bundled cable in row 406. On the other hand, the data rate column 404 of the illustrated example of FIG. 4 may alternatively refer to individual cable pair data rates, such as the example data rate of 1.544 Mbps for the cable pair in row 408.

In the illustrated example, a circuit type column 410 identifies the type of broadband services employed on particular bundled cables and/or cable pairs of corresponding locations of the location column 402. For example, zone “1” of city “A” includes a bundled cable that provides ADSL and VDSL services (row 406), whereas zone “3” of city “A” includes a bundled cable providing VDSL broadband services (row 412). Additionally, the circuit type column 410 also identifies the broadband services for individual cable pairs. Persons of ordinary skill in the art will appreciate that a single bundled cable may include many individual cable pairs, each of them providing various types of broadband services. Zone “3” of city “B,” for example, includes a bundled cable that provides ADSL and HDSL services (row 414). In the illustrated example of FIG. 4, the individual cable pairs for zone “3” of city “B” have been expanded, causing ten cable pair rows 416 to be listed. Each individual cable pair within the bundled cable is identified with a corresponding data rate in the data rate column 404 and a corresponding circuit type in the circuit type column 410.

In the example of FIG. 4, an up-direction bit rate column 418 and a down-direction bit rate column 420 identify bit rate parameters for corresponding bundled cables and/or cable pairs. As discussed above, rows that are not expanded (bundled cables) may display average values corresponding to the particular measurement for the corresponding cable pairs. For example, row 406 illustrates a bundled cable with fifty cable pairs that result in an average up-direction bit rate of 210 Kbps (422) and an average down-direction bit rate of 512 Kbps (424). The up-direction bit rate column 418 and the down-direction bit rate column 420 also identify specific bit rates for individual cable pairs, such as the expanded cable pairs 416 of zone “3.” Persons of ordinary skill in the art will appreciate that the respective measurements may be shown as specific snapshot measurements in time, or as average values resulting from multiple discrete measurements at various points in time.

Each row of the performance table 400 of the illustrated example of FIG. 4 includes a date stamp, as shown in a date column 426. Rows with a “+” symbol next to a date represent additional data points that may be viewed upon selecting the “+” symbol to expand. On the other hand, a “*” symbol next to the date indicates only one data point exists for that particular row. As discussed above, various analysis techniques on recent (current) and historical performance and topology data are beneficial for network administrators when qualifying a bundled cable and/or cable pair for broadband services. While the illustrated example performance table 400 shows a data rate column 404, a circuit type column 410, an up-direction bit rate column 418, a down-direction bit rate column 420, and a date column 426, persons of ordinary skill in the art will appreciate that any number of additional columns may be included in the performance table 400.

In the illustrated example, an expand button 428 allows additional performance metrics to be viewed in addition to, or instead of, the columns shown in the example performance table 400 of FIG. 4. For example, the expand button 428, when selected by the user(s), may cause the user(s) to be presented with a dialog selection box to choose additional engineering metrics/parameters to view. Additional engineering performance metrics may include, but are not limited to, latency, average eye width, average eye height, average eye jitter, and/or whether any eye diagram mask violations have occurred. Also shown in the illustrated example performance table 400 of FIG. 4 are eye buttons 430 next to corresponding rows showing individual cable pair data, such as the expanded cable pairs 416 of zone “3.” Persons of ordinary skill in the art will appreciate that a database, such as the engineering database 220, may store text data, numerical data, and/or graphical data.

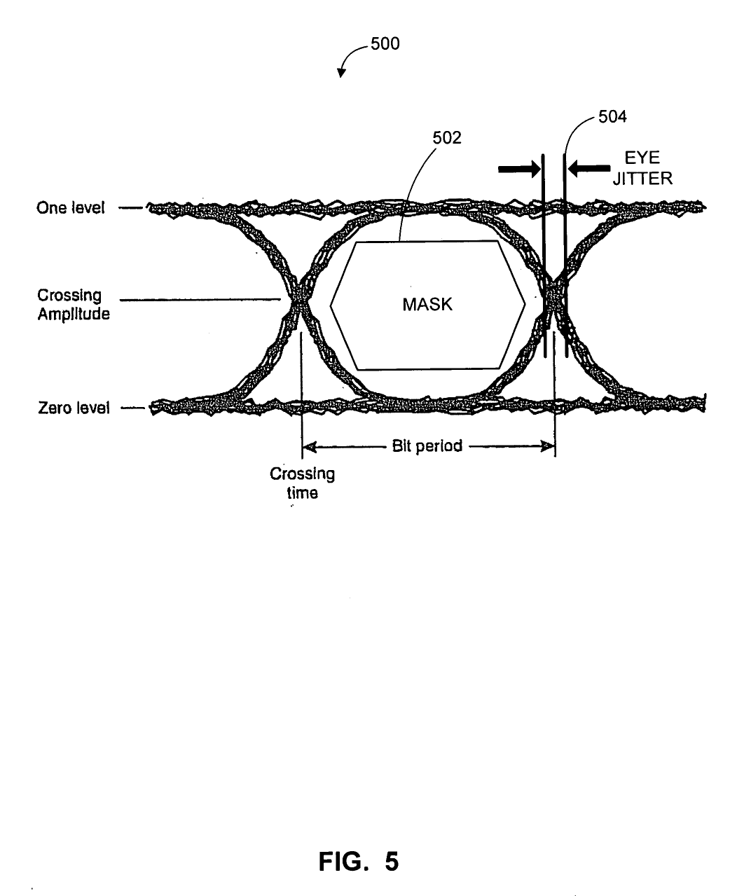

When the user(s) select the eye button 430 for any particular row, a corresponding eye diagram is presented to the user(s), such as the example eye diagram 500 shown in FIG. 5. Additionally or alternatively, the user(s) may have access to multiple eye diagrams taken at different points in time to allow an analysis of general signal performance before and/or after various changes have taken place. For example, FIG. 5 may represent a baseline eye diagram for a cable pair that is providing broadband services in an acceptable manner. The example eye diagram 500 of FIG. 5 includes a mask 502 for which no violations occur. Additionally, the example eye diagram 500 illustrates an eye jitter 504 that may be deemed acceptable for certain broadband services. While explicit values for the eye jitter 504 are not shown in the example eye diagram 500 of FIG. 5, persons of ordinary skill in the art will appreciate that the eye diagram(s) stored in the engineering database 220 may include relative time (e.g., unit interval time), relative amplitudes, and/or explicit times and/or amplitudes to quantify various eye diagram parameters. Without limitation, the eye diagram may include indicators for logic overshoot (e.g., for logic 1 and/or logic 0), logic undershoot (e.g., for logic 1 and/or logic 0), eye width, 20-to-80% rise time(s), and/or 80-to-20% fall time(s).

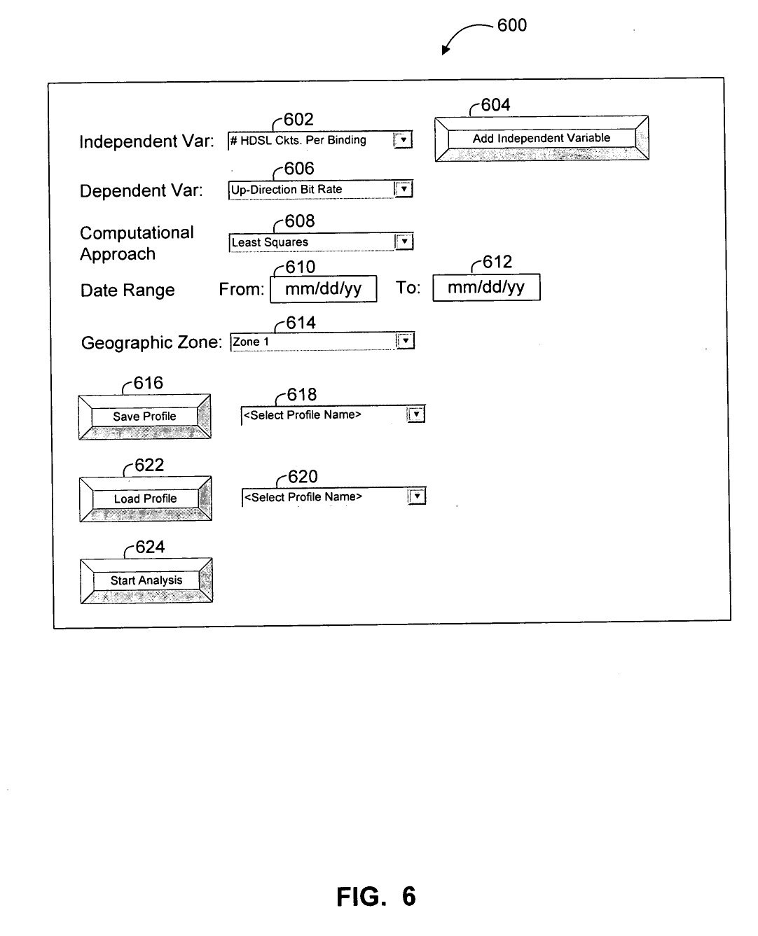

FIG. 6 is an example graphical user interface (GUI) 600 displayed by the web server 216 and/or GUI module 218 of FIG. 2. The illustrated example GUI 600 includes several drop down menus to allow the user(s) to select various settings prior to performing data analysis functions of the network planner 122. An independent variable drop down menu 602 displays a list of independent variables from which the user(s) may select for analysis. As discussed above, a regression analysis allows relationships to be determined between one or more independent variables and a dependent variable. Once a regression analysis has been performed, a regression line equation may be determined to help the user(s) understand expected future performance. With such information, a network planner may qualify existing POTS cable pairs and/or bundled cables for broadband services. In the event the user(s) needs additional independent variables for the analysis, an “Add Independent Variable” button 604 may be selected, which causes the GUI 600 to add an additional independent variable drop down menu named, for example, “Independent Variable 2.” In the illustrated example, the independent variable drop down menu 602 shows “Num. of HDSL Circuits Per Binder.” Without limitation, alternate independent variable selections may include the number of any other type of circuit (e.g., VDSL, ADSL, etc.), the number of circuits per binder with a signal power greater than a predetermined value, and/or the number of shielded circuits per binder. Various selections for the drop down menus may be based on the available types of data in the engineering database 220 and/or the planning database 222. Similar to the independent variable drop down menu 602, a dependent variable drop down menu 606 displays a list of dependent variables from which the user(s) may select for analysis.

In the example of FIG. 6, a computational approach drop down menu 608 allows the user(s) to select from any number of techniques to fit data points to a straight line. While specific computation approach techniques may depend upon a particular type of statistical manager 210 (e.g., Mathematica®, SAS®, etc.), the computational approach techniques may include, but are not limited to, a least squares technique, a partial correlation technique, and/or fitting centered polynomial models. The example analysis GUI 600 also includes a starting date entry box 610 and an ending date entry box 612 to allow the user(s) to constrain the data analysis within any particular range of dates. As discussed above, each data entry into the engineering database 220 and the planning database 222 includes a date/time stamp to identify when the data was acquired. The starting and ending date range entry boxes 610, 612 are particularly helpful when, for example, the user executes an analysis on a specific zone for separate dates, thereby allowing the user to observe infrastructure performance trends. If jitter rates increase, crosstalk effects increase, bit errors increase, and/or overshoot/undershoot characteristics increase, then the user may identify that, for example, a relatively large number of new subscribers now consume broadband services within a particular bundled cable. Accordingly, the user may begin to establish new rules to be applied to a network infrastructure that is based on empirical data, thereby preventing broadband service anomalies and/or subscriber complaints before they occur. One such rule may include, for example, avoiding implementing more than 25% of the cable pairs in an unshielded bundled cable with VDSL. Another such example rule may prohibit broadband circuits served from the CO location to be mixed into binders with broadband circuits fed from a Remote Terminal unless the power is throttled on the Remote Terminal fed circuits.

In the example of FIG. 6, a geographic zone drop down box 614 allows the user(s) to select one or more zones and/or cable pairs within the infrastructure. In the event that the user(s) wants to re-run an analysis at a later date, such as when more data points have been stored in the engineering database 220 and/or the planning database 222, a save profile button 616 allows the user(s) to save all of the individual analysis settings using any particular file name by entering alphanumeric characters in a profile name entry field 618. As discussed above, the qualification manager 206 of the illustrated example includes a memory to store profiles for later recall. Similarly, the user(s) may select a profile name drop down box 620 to search for prior stored profiles and select a load profile button 622 when a desired profile is found.

If the user(s) selects a start analysis button 624, the qualification manager 206 of the illustrated example compiles corresponding data from the engineering database 220 and the planning database 222, and submits the collected data to the statistical manager 210 for analysis (e.g., a regression analysis). Data compilation may include gathering multiple subsets of data from the databases that correspond to the start date, end date, geographic zone, and data types related to the independent and dependent variables selected with the GUI 600. Persons of ordinary skill in the art will appreciate that the qualification manager 206, the performance manager 202, and/or the topology manager 204 may include a structured query language (SQL) engine, such as Microsoft® SQL Server®, to create query commands and extract data from the databases (220, 222). In the illustrated example, subsets of relevant data that are generated by the qualification manager 206 (and/or the performance manager 202, and/or the topology manager 204) are passed to the statistical manager 210 for computational analysis.

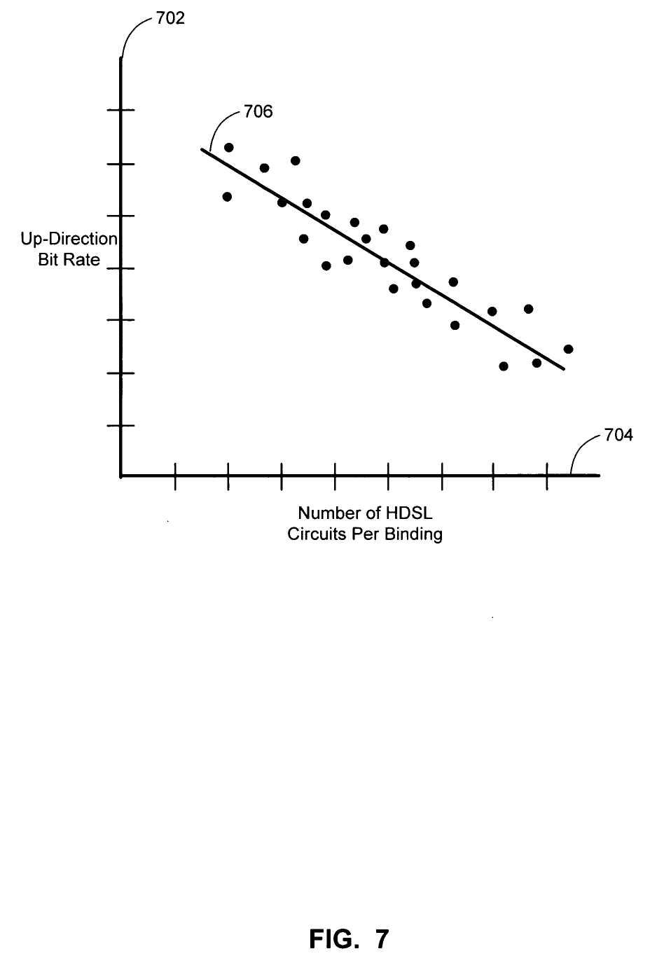

An example output graph 700 generated by the example statistical manager 210 is shown in FIG. 7. In the illustrated example, a y-axis 702 represents the up-direction bit rate (dependent variable) and an x-axis 704 represents the number of HDSL circuits per binding (independent variable). The statistical manager 210 of the illustrated example utilizes dots to represent the data points of the regression analysis, and generates a line 706 that, in the illustrated example, corresponds to a linear equation corresponding to the data points (i.e., y=Mx+b).

In the illustrated example, the user may select any one of the data points to cause a pop-up window to appear with specific details about the selected data point. For example, selecting a data point may display the geographic zone corresponding to the selected point, the date upon which the data was measured/acquired corresponding to the selected point, and/or an eye diagram image of the cable pair corresponding to the selected point. The calculated line generated as a result of the regression analysis illustrates an indication of expected performance when various parameters approach high and/or low limits. In the illustrated example graph 700 of FIG. 7, the relationship between up-direction bit rate and the number of HDSL circuits per binding is shown, wherein the bit rate generally decreases as the number of HDSL circuits in the binding increases. Accordingly, user(s) may obtain some valuable insight on limitations of a network infrastructure, generate network construction rules to minimize and/or prevent adverse broadband service performance, and/or qualify existing POTS infrastructure bundled cables and/or cable pairs for particular broadband services using the apparatus of FIG. 2.

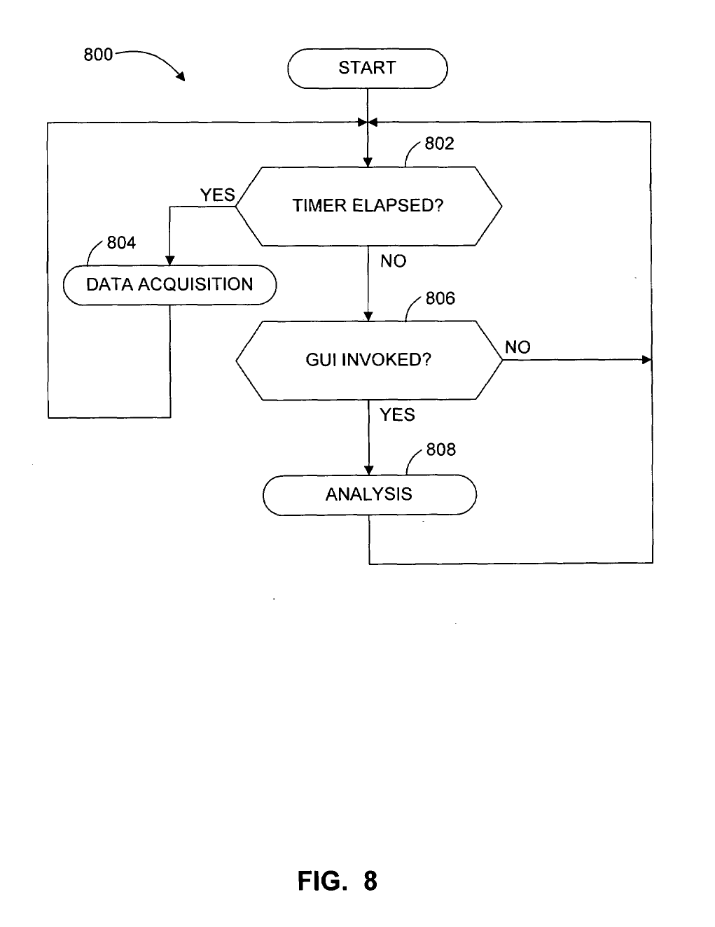

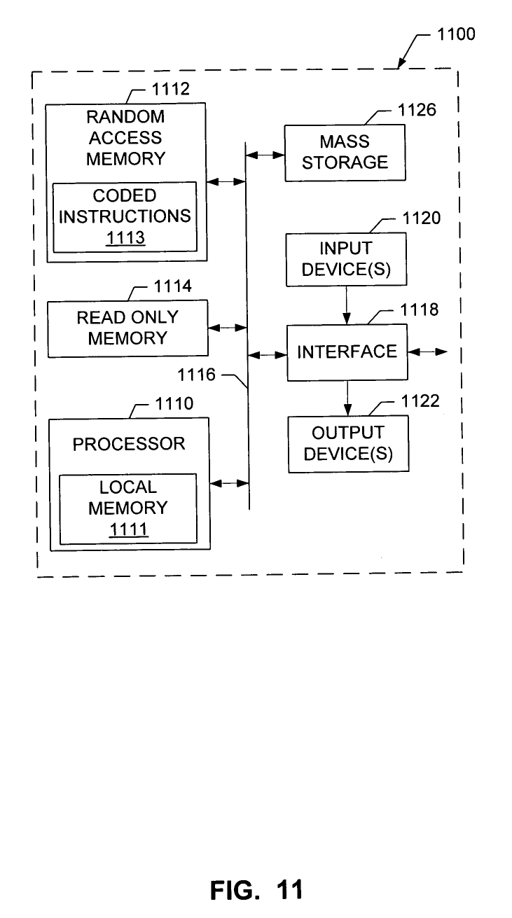

Flowcharts representative of example machine readable instructions for implementing methods and apparatus for qualifying POTS circuits for broadband services are shown in FIGS. 8-10. In this example, the machine readable instructions comprise a program for execution by: (a) a processor such as the processor 1110 shown in FIG. 11, which may be part of a computer, (b) a controller, and/or (c) any other suitable processing device. The program may be embodied in software stored on a tangible medium such as, for example, a flash memory, a CD-ROM, a floppy disk, a hard drive, a digital versatile disk (DVD), or a memory associated with the processor 1110, but persons of ordinary skill in the art will readily appreciate that the entire program and/or parts thereof could alternatively be executed by a device other than the processor 1110 and/or embodied in firmware or dedicated hardware in a well known manner. For example, any or all of the example network planner 122, the performance manager 202, the topology manager 204, the qualification manager 206, the statistical manager 210, the engineering database 220, the planning database 222, the network interface 212, the web server 216, and/or the GUI module 218 could be implemented by software, hardware, and/or firmware (e.g., it may be implemented by an application specific integrated circuit (ASIC), a programmable logic device (PLD), a field programmable logic device (FPLD), discrete logic, etc.).

Also, some or all of the machine readable instructions represented by the flowcharts of FIGS. 8-10 may be implemented manually. Further, although the example program is described with reference to the flowcharts illustrated in FIGS. 8-10, persons of ordinary skill in the art will readily appreciate that many other methods of implementing the example machine readable instructions may alternatively be used. For example, the order of execution of the blocks may be changed, and/or some of the blocks described may be changed, substituted, eliminated, or combined.

The example process 800 of FIG. 8 begins at block 802 where the qualification manager 206 of the network planner 122 determines if a data acquisition timer has elapsed. If the data acquisition timer has elapsed, a data acquisition process begins (block 804). On the other hand, if the data acquisition timer has not elapsed, then the qualification manager 206 determines if a user is requesting services of the network planner 122 by receiving a signal from the GUI module 218 (block 806). The user(s) may interact with the network planner 122 via a hardwired kiosk, personal computer, and/or server communicatively connected to the network planner 122 via, for example, an intranet connection. Additionally or alternatively, the user(s) may interact with the network planner 122 via the web server 216 of the network interface 212 via the intranet and/or Internet connection. Persons of ordinary skill in the art will appreciate that authentication, authorization, and/or encryption techniques may be employed to prevent unauthorized use and/or monitoring of the network planner 122. If the qualification manager 206 does not receive a signal that a user is interacting with the GUI module 218, then control returns to block 802. Otherwise, the qualification manager 206 initiates an analysis procedure (block 808).

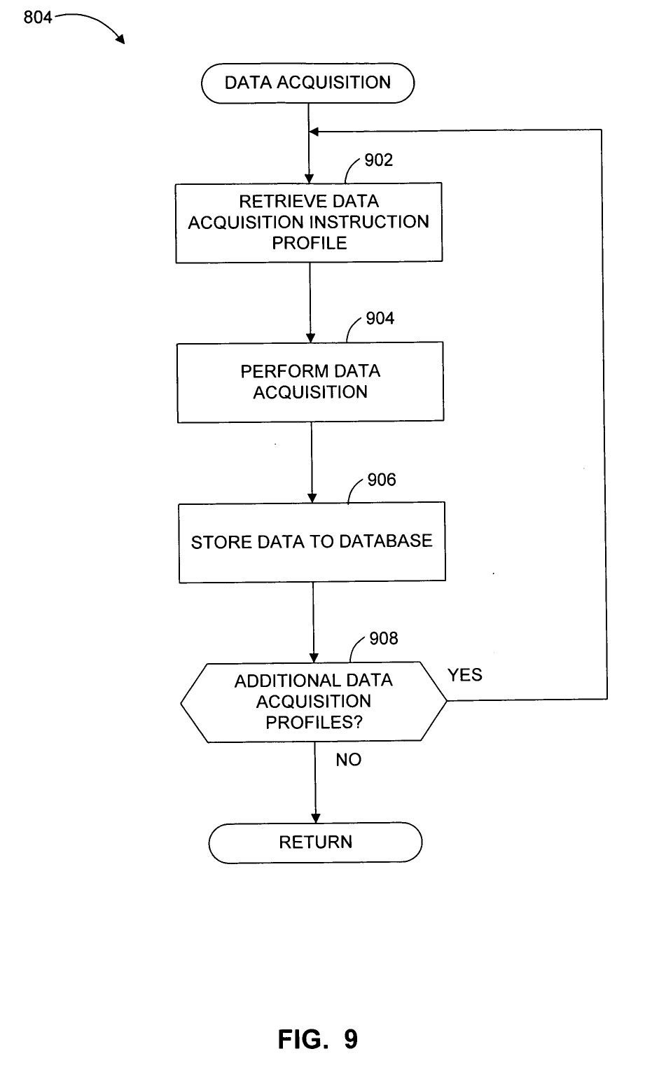

The example data acquisition process (block 804) of FIG. 9 begins at block 902. The qualification manager 206 signals the performance manager 202 to initiate data acquisition procedures by retrieving data acquisition instructions from an acquisition profile (block 902). For example, the performance manager 202 may store any number of acquisition profiles that instruct the T&M equipment 208 to measure various performance characteristics of cable pairs in a bundled cable. Additionally, the acquisition profile may instruct the T&M equipment 208 to invoke arbitrary waveform generator(s) and/or signal generators to apply various test signals on cable pairs before taking measurements of one or more test cable pairs. For example, a profile of the performance manager 202 may instruct the T&M equipment 208 to apply varying power levels in a stepped fashion to a single cable pair. As the steps iterate, power levels are increased starting with, for example, a relatively low power. In the illustrated example, after each application of a predetermined power level, the T&M equipment 208 measures one or more adjacent cable pairs for power levels and/or signal frequency variations that may be caused by interference from the test power signal (block 904).

Results from each of the stepped power signals and corresponding measurements of the adjacent cable pairs are stored in a memory of the performance manager 202 and/or T&M equipment 208 until the stepped sequence (e.g., ten steps incremented by 2 dB per step) is complete. Completed batches of data acquisition procedures are stored to the engineering database 220 (block 906) and the performance manager 202 determines whether additional acquisition profiles exist for alternate and/or additional tests on the network infrastructure (block 908). If additional acquisition profiles are to be executed (block 908), then control returns to block 902. Otherwise, control returns to block 806 of FIG. 8.

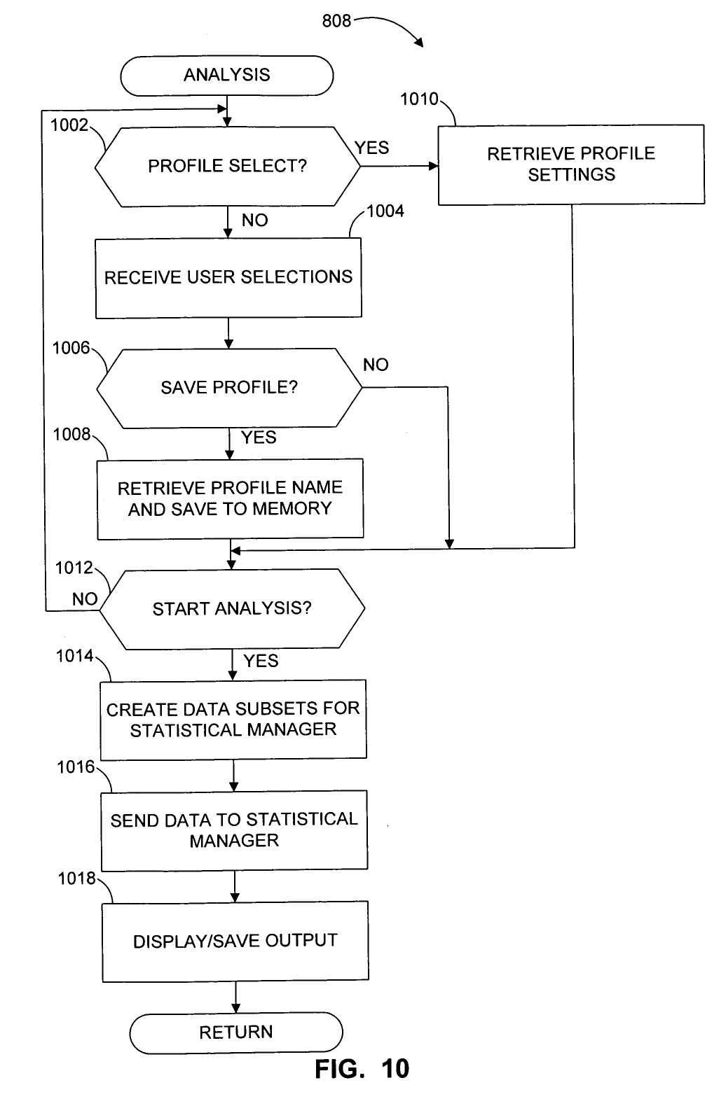

The example analysis process (block 808) of FIG. 10 begins at block 1002. The qualification manager 206, via the GUI module 218 or via access to the GUI via the web server 216, determines if the user(s) selects an existing profile from the profile name drop down box 620 of FIG. 6 (block 1002). If not, then the qualification manager 206 receives user selections from the GUI (block 1004). As discussed above in view of the example GUI 600 of FIG. 6, the user(s) may select independent variables, dependent variables, computational approach techniques, date ranges, and/or geographic zones for analysis. After making such selections for an analysis, the qualification manager 206 determines whether the entered values should be saved as a new profile (block 1006). For example, the user(s) may anticipate that this same arrangement of selections might be of interest in the future after additional data points have been acquired over time. Additionally, the user(s) may anticipate that a substantially similar profile may be useful in the future with minor selection modifications, thereby saving the user(s) a significant amount of time by not having to make all of the selections over again. If the user(s) decide to save the existing profile, the qualification manager receives a profile name that is entered into the profile name entry field 618 in response to the user(s) selection of the save profile button 616 (block 1008).

Briefly returning to block 1002, if the user selects a profile name from the profile name drop down box 620 and selects the load profile button 622, the qualification manager 206 extracts the user selections from the selected profile and populates the respective fields (i.e., independent variables, dependent variables, computational approach, date ranges, and geographical zone) (block 1010) of the GUI 600 of FIG. 6. As discussed above, various profiles are saved in a memory of the qualification manager 206 for later recall. After populating the field (block 1010), control proceeds to block 1012.

At block 1012, the qualification manager determines whether the user(s) has selected the start analysis button 624. If so, control advances to block 1014. If not, control returns to block 1002. Additionally, or alternatively, control could return to block 1010, thereby allowing the user(s) to select a profile from the memory of the qualification manager 206 and/or to enter data (blocks 1004-1008) as explained above.

When the user selects the start analysis button 624 (block 1012), the qualification manager 206 creates appropriate data subsets based on the received user selections (block 1014). In the illustrated example, the qualification manager 206 includes a SQL engine to create SQL commands and extract data from the engineering database 220 and/or the planning database 222 based on the parameters identified by the user via the GUI. Results from the SQL commands issued by the qualification manager 206 are sent to the statistical manager 210 for data analysis (e.g., regression analysis) (block 1016). When the statistical manager 210 completes analysis of the received data sets, a tabular and/or graphical output is generated, such as the example graphical output of FIG. 7 (block 1018). Such tabular and/or graphical output may additionally or alternatively be saved to memory for later recall and/or study by the network engineer, service provider, communication carrier owner(s), etc.

FIG. 11 is a block diagram of an example computer 1100 capable of executing the example machine recordable instructions represented by the flowcharts of FIGS. 8-10 to implement the apparatus and methods disclosed herein. The computer 1100 can be, for example, a server, a personal computer, a laptop, a PDA, or any other type of computing device.

The computer 1100 of the instant example includes a processor 1110 such as a general purpose programmable processor. The processor 1110 includes a local memory 1111, and executes coded instructions 1113 present in the local memory 1111 and/or in another memory device. The processor 1110 may execute, among other things, the example processes illustrated in FIGS. 8-10. The processor 1110 may be any type of processing unit, such as a microprocessor from the Intel® Centrino® family of microprocessors, the Intel® Pentium® family of microprocessors, the Intel® Itanium® family of microprocessors, the Intel XScale® family of processors, and/or the Motorola® family of processors. Of course, other processors from other families are also appropriate.

The processor 1110 is in communication with a main memory including a volatile memory 1112 and a non-volatile memory 1114 via a bus 1116. The volatile memory 1112 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1114 may be implemented by flash memory and/or any other desired type of memory device. Access to the main memory 1112, 1114 is typically controlled by a memory controller (not shown) in a conventional manner.

The computer 1100 also includes a conventional interface circuit 1118. The interface circuit 1118 may be implemented by any type of well known interface standard, such as an Ethernet interface, a universal serial bus (USB), and/or a third generation input/output (3GIO) interface.

One or more input devices 1120 are connected to the interface circuit 1118. The input device(s) 1120 permit a user to enter data and commands into the processor 1110. The input device(s) can be implemented by, for example, a keyboard, a mouse, a touchscreen, a track-pad, a trackball, isopoint and/or a voice recognition system.

One or more output devices 1122 are also connected to the interface circuit 1118. The output devices 1122 can be implemented, for example, by display devices (e.g., a liquid crystal display, a cathode ray tube display (CRT), a printer and/or speakers). The interface circuit 1118, thus, typically includes a graphics driver card.

The interface circuit 1118 also includes a communication device such as a modem or network interface card to facilitate exchange of data with external computers via a network (e.g., an Ethernet connection, a digital subscriber line (DSL), a telephone line, coaxial cable, a cellular telephone system, etc.).

The computer 1100 also includes one or more mass storage devices 1126 for storing software and data. Examples of such mass storage devices 1126 include floppy disk drives, hard drive disks, compact disk drives and digital versatile disk (DVD) drives. The mass storage device 1126 may implement the memory of the qualification manager 206, the engineering database 220, and/or the planning database 222.

At least some of the above described example methods and/or apparatus are implemented by one or more software and/or firmware programs running on a computer processor. However, dedicated hardware implementations including, but not limited to, application specific integrated circuits, programmable logic arrays and other hardware devices can likewise be constructed to implement some or all of the example methods and/or apparatus described herein, either in whole or in part. Furthermore, alternative software implementations including, but not limited to, distributed processing or component/object distributed processing, parallel processing, or virtual machine processing can also be constructed to implement the example methods and/or apparatus described herein.

It should also be noted that the example software and/or firmware implementations described herein are optionally stored on a tangible storage medium, such as: a magnetic medium (e.g., a magnetic disk or tape); a magneto-optical or optical medium such as an optical disk; or a solid state medium such as a memory card or other package that houses one or more read-only (non-volatile) memories, random access memories, or other re-writable (volatile) memories; or a signal containing computer instructions. A digital file attached to e-mail or other information archive or set of archives is considered a distribution medium equivalent to a tangible storage medium. Accordingly, the example software and/or firmware described herein can be stored on a tangible storage medium or distribution medium such as those described above or successor storage media.

To the extent the above specification describes example components and functions with reference to particular standards and protocols, it is understood that the scope of this patent is not limited to such standards and protocols. For instance, each of the standards for Internet and other packet switched network transmission (e.g., Transmission Control Protocol (TCP)/Internet Protocol (IP), User Datagram Protocol (UDP)/IP, HyperText Markup Language (HTML), HyperText Transfer Protocol (HTTP)) represent examples of the current state of the art. Such standards are periodically superseded by faster or more efficient equivalents having the same general purpose. Accordingly, replacement standards and protocols having the same general purpose are equivalents to the standards/protocols mentioned herein, and contemplated by this patent, are intended to be included within the scope of the accompanying claims.

This patent contemplates examples wherein a device is associated with one or more machine readable mediums containing instructions, or receives and executes instructions from a propagated signal so that, for example, when connected to a network environment, the device can send or receive voice, video or data, and communicate over the network using the instructions. Such a device can be implemented by any electronic device that provides voice, video and/or data communication, such as a telephone, a cordless telephone, a mobile phone, a cellular telephone, a Personal Digital Assistant (PDA), a set-top box, a computer, and/or a server.

Additionally, although this patent discloses example software or firmware executed on hardware and/or stored in a memory, it should be noted that such software or firmware is merely illustrative and should not be considered as limiting. For example, it is contemplated that any or all of these hardware and software components could be embodied exclusively in hardware, exclusively in software, exclusively in firmware or in some combination of hardware, firmware and/or software. Accordingly, while the above specification described example methods and articles of manufacture, persons of ordinary skill in the art will readily appreciate that the examples are not the only way to implement such methods and articles of manufacture. Therefore, although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A method to analyze network performance comprising:
receiving a time period to analyze broadband network spectral compatibility;
retrieving circuit operating metrics of a first and a second twisted copper pair circuit during the time period; and
qualifying at least one of a first or a second plain old telephone system (POTS) twisted copper pair circuit for broadband services to determine the network spectral compatibility based on the operating metrics.

2. A method as defined in claim 1 further comprising collecting circuit topology information of the at least one of the first or the second POTS twisted copper pair circuits in a POTS network, the topology information comprising first and second twisted cable pair parameters.

3. A method as defined in claim 2 wherein qualifying POTS first and second twisted copper pair circuits comprises analyzing the circuit topology information and the circuit operating metrics of the first and second twisted copper pair circuits to determine at least one performance characteristic in response to at least one of an effect of an operating state of the first circuit on the second circuit, or an effect of an operating state of the second circuit on the first circuit.

4. A method as defined in claim 3 further comprising:
driving at least one of the first circuit or the second circuit; and
measuring a network performance characteristic of at least one of the first or second circuits.

5. A method as defined in claim 2 wherein collecting circuit topology information comprises retrieving twisted cable pair parameters from a network planning database.

6. A method as defined in claim 5 wherein the network planning database comprises history information concerning twisted cable pair topology.

7. A method as defined in claim 2 wherein at least one of the first or second twisted cable pair parameters comprise at least one of cable length, cable gauge, cable age, cable sheath type, cable location, or cable transceiver terminator location.

8. A method as defined in claim 1 wherein retrieving circuit operating metrics comprises receiving circuit operating metrics from an engineering database.

9. A method as defined in claim 1 wherein the circuit operating metrics comprise at least one of transmission signal power spectral density, transmission signal data rate, transmission signal error rate, or crosstalk.

10. A method as defined in claim 1 wherein qualifying the at least one of the first or the second POTS twisted copper pair circuit comprises performing multi-variant regression analysis on the first and second twisted copper pair circuits.

11. A method as defined in claim 10 wherein the at least one of the first or the second POTS twisted copper pair circuits is excited with electrical test parameters comprising at least one of signal power adjustments, signal on/off, or signal data rate adjustments.

12-23. (canceled)

24. An article of manufacture storing machine readable instructions which, when executed, cause a machine to:
receive a time period to analyze broadband network spectral compatibility;
retrieve circuit operating metrics of the first and second twisted copper pair circuits during the time period; and
qualify at least one of a first or a second plain old telephone system (POTS) twisted copper pair circuit for broadband services to determine the network spectral compatibility based on the operating metrics.

25-33. (canceled)

34. A network planning apparatus comprising:
a topology manager to receive plain old telephone system (POTS) network topology data;
a performance manager to receive POTS network performance data;
a qualification manager to receive analysis requests and to actuate at least one of the topology manager and the performance manager to retrieve POTS topology data and performance data in response to the analysis request; and
a statistical manager to process the addition of the POTS topology data and the performance data to determine if at least one POTS twisted cable pair is qualified to provide a broadband service.

35. An apparatus as defined in claim 34 further comprising an engineering database to store the network performance data and a planning database to store the network topology data.

36. An apparatus as defined in claim 35 further comprising a network interface to facilitate communication between at least one of the topology manager, the performance manager, the qualification manager, or the statistical manager and at least one of the engineering database or the planning database.

37. An apparatus as defined in claim 34 further comprising test and measurement equipment to collect performance data of the POTS network.

38. An apparatus as defined in claim 37 wherein the test and measurement equipment comprises at least one of an operational circuit broadband transceiver, an oscilloscope, a spectrum analyzer, a network analyzer, a logic analyzer, a protocol analyzer, a bit-error-rate tester, or an arbitrary waveform generator.

39. An apparatus as defined in claim 34 further comprising a web server to generate a graphical user interface (GUI), the GUI displaying at least one of a topology table, a performance table, or a data plot.

40. An apparatus as defined in claim 39 wherein the data plot comprises at least one of an independent variable, a dependent variable, or a linear relationship equation.

41. An apparatus as defined in claim 39 wherein the GUI comprises a network analysis screen area to display a plurality of network analysis parameters.

42. An apparatus as defined in claim 41 wherein the plurality of network analysis parameters comprise at least one of an independent variable, a dependent variable, a computational approach, a date range, or a geographic zone.
